(19) United States
(12) Patent Application Publication
(10) Pub. No.: US 2014/0279567 A1
(43) Pub. Date: Sep. 18, 2014

(54) NEGOTIATION FACILITATING SYSTEM WITH TWO AUTOMATED NEGOTIATING AGENTS

(71) Applicant: InKomerce, Inc., Marina del Rey, CA (US)

(72) Inventors: Ronen Moldovan, Ilaniya (IL); Gershon Wajntraub, Marina del Rey, CA (US)

(73) Assignee: InKomerce, Inc., Marina del Rey, CA (US)

(21) Appl. No.: 14/212,343

(22) Filed: Mar. 14, 2014

Related U.S. Application Data
(60) Provisional application No. 61/785,566, filed on Mar. 14, 2013.

(51) Int. Cl. G06Q 50/18; G06Q 30/00

(52) U.S. Cl. CPC G06Q 50/188; G06Q 30/00
USPC 705/80

(57) ABSTRACT

An apparatus and method for facilitating a negotiation between users which includes assigning a first negotiation agent and a second negotiating agent, receiving max and min price, determining a first and second offer, and reducing the first offer and increasing the second offer alliteratively until agreement or disagreement is reached.

### CROSS-REFERENCES TO RELATED APPLICATIONS

This application claims priority from U.S. Application No. 61/785,566, filed Mar. 14, 2013 incorporated by reference in its entirety.

### BACKGROUND

Since the introduction of the internet, e-commerce (the buying and selling of goods or services online) has gained wide popularity worldwide. Almost any product or service can be obtained anywhere in the world from an e-commerce site, whether it be a multinational e-commerce company such as Amazon.com, Ebay.com, and Newegg.com; a personal e-commerce storefront; or a provider of individual storefronts such as Etsy.com.

With the advent of the many e-commerce sites, consumers are able to easily conduct price comparisons. A consumer can pull up several different e-commerce websites on their web browser and compare the prices on each website. Most of these e-commerce websites have normegotiable prices on their goods and services. Without the ability to negotiate, the consumer usually buys the good or service from the site with the lowest advertised price. As a result, if an e-commerce website does not advertise a competitive price, they will lose customers to competing websites until they update to a more competitive price. However, some sites have multiple products up for sale at a time, and updating each product price regularly is cumbersome and time consuming.

Furthermore, the ease of price comparisons of e-commerce sites has detrimentally affected brick and mortar retailers. Often times, the prices at a brick and mortar retailer are normegotiable prices which are above the advertised prices at an e-commerce website. Because of this, consumers have started using brick and mortar retailers for inspecting a product before buying it from an internet marketplace. Brick and mortar retailers have essentially become a showroom for e-commerce sites. The inability for brick and mortar stores to negotiate and competitively price their goods and services against e-commerce sites has caused them to lose many potential customers.

Providing a platform for the sellers and buyers to negotiate prices would help solve some of the problems describe above. However, one of the difficulties in providing a negotiation platform is negotiation experience. Negotiating is a complicated process where an expert negotiator may be able to take advantage of someone's inexperience. This may cause one to leave a transaction feeling duped or even prevent them from negotiating in the first place. Furthermore, e-commerce sites and brick and mortar retailers conduct an enormous number of sales on a regular bases; thus, having a human negotiate every sale would be impractical.

Therefore, a system and method for dynamically providing competitive prices for products through a negotiation platform that bridges the gap of negotiation experience and has the ability to automate negotiations is needed. Such a system would provide for real time negotiation and real time closing of deals associated with the negotiation. The present invention satisfies these, and other needs.

### SUMMARY OF THE INVENTION

In its most general aspect, the invention includes a system and method for assisting sales by providing a negotiator on behalf of the interested parties.

In one aspect, the invention includes a system and a method for negotiating a price comprising, receiving a maximum price and a minimum price, assigning a first negotiating agent to a first user and a second negotiating agent to a second user, determining a first user's offer price and a second user's offer price, the first agent increasing the first user's offer price and displaying it to the second user and requesting a first new price from the second user; and the second agent decreasing the second user's offer price and displaying it to the first user and requesting a second new price from the first user.

In another aspect, the invention includes a system comprising one or more processors; one or more displays; and logic encoded in one or more non-transitory computer-readable media that, when executed by the one or more processor, is operable to receive a maximum price and a minimum price from one or more users; determine a first user's offer and a second user's offer; increase the first user's offer price and request a first new price from the second user; and decrease the second user's offer and request a second new price from the first user.

In yet another aspect, the invention includes a non-transitory computer-readable medium storing instructions that, when executed by a processor, perform a method comprising receiving a maximum price and minimum price; assigning a first computerized negotiating agent to a first user; assigning a second computerized negotiating agent to a second user; determining a first user's offer and a second user's offer price; the first agent increasing the first user's offer price and displaying it to the second user and requesting a first new price from the second user; and the second agent decreasing the second user's offer price and displaying it to the first user and requesting a second new price from the first user.

In another aspect, the invention provides for real time negotiation of deals. In still another aspect, the invention provides for real time closing of the negotiated deals.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 illustrates an exemplary network environment on an exemplary negotiation system.

FIG. 2 is a flow chart of an exemplary implementation of a negotiation platform.

FIG. 3 illustrates an exemplary interaction during the negotiation phase of the negotiation platform

FIG. 4 is a flow chart of an exemplary negotiation phase of a negotiation platform.

FIG. 5 illustrates an exemplary computer system architecture.

### DETAILED DESCRIPTION

As will be described hereinafter in greater detail, the various embodiments of the present invention relates to an automated negotiation system and method which assists buyers and sellers to bridge a price gap by negotiating on behalf of each party. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

FIG. 1 illustrates an exemplary Negotiation System 100 according to one embodiment of the present invention. Negotiation System 100 may have one or more Negotiation Platforms 101 which may be one or more computer systems and may connect to Network Cloud 102. Network Cloud 102 generally represents a network or collection of networks (such as the Internet, private intranet, or a combination of both) over which one or more client devices 103 may interact with one or more Negotiating Platforms 101. Negotiation Platforms 101 may contain one or more Item Databases 101a, which may be used for storing a database of items that one or more Clients 103 may have posted as a request or for sale; one or more Negotiation Application Servers 101b, which may be used for facilitating the negotiation between parties through an application; and one or more Front End Negotiation Web Servers 101c, which may be used to provide the one more Clients 103 the ability to interact with the Negotiation Platform through a webpage or other interfaces.

According to one embodiment, Negotiating Platforms 101 may be a unitary server or may be a distributed server spanning multiple computers or multiple data centers. Additionally, each server within the Negotiation Platform may be part of a unitary server, be a unitary server, or be a distributed server spanning multiple computers or multiple datacenters. The term servers may refer to various types of servers, such as, for example and without limitation, a web server, news server, mail server, message server, advertising server, file server, application server, exchange server, database server, proxy server, etc.

Clients 103 may be a computer system which runs one or more operating systems (such as, for example, Windows, iOS, Android, Unix, Linux, and the like) and executes one or more client applications, such as a web browser (e.g. Internet Explorer, Firefox, Safari, Chrome, Opera, etc.). Client 103 may have users using the clients. A user at Client 103 may enter a uniform Resource Locator (URL) or other address directing a web browser to a server, and the web browser may generate a Hyper Text Transfer Protocol (HTTP) request and communicate the HTTP request to a server. The server may accept the HTTP request. Client 103 may render a web page based on the HTML files from a server. As an example and not by way of limitation, web pages may render from one or more combinations of HTML, XHTML, XML, Java Script, Java, Microsoft Silverlight, AJAX, and the like.

Negotiation Platform 101 may consist of one or more computer systems. Additionally, Client 103, Item Database 101a, Negotiation Application Server 101b, and Front End Negotiation Web Server 101c each may consist of one or more computer systems in communications with each other. As an example and not by way of limitation, communications between computer systems may be implemented using communication protocols such as UDP, JSON, SMS, and the like.

In one embodiment, Clients 103 may be one or more computer systems located in a brick and mortar retailer for facilitating negotiations with customers. The computer system may be connected to a product identifier (such as a barcode scanner) where a potential customer may scan an item for identification and pricing. Item Database 101a may contain an inventory of items the brick and mortar retailer has for sale.

FIG. 2 is an exemplary flowchart illustrating an implementation of a negotiation platform initiated by a seller's listing of a good or service according to one embodiment of the present invention. Negotiation platform 200 begins at 201 with the negotiation platform 200 receiving an item for sale with a minimum sale price Psmin and initial sale offer price Pso from a seller. In one embodiment, Pso may be automatically determined through an algorithm. Pso may be a set increase based on a percentage of Psmin, for example, 20% above Psmin. In another embodiment there may be a percentage range that is chosen randomly or through a weighted random percentage; for example, Pso may be a percentage increase of Psmin between 10-20% with 15-20% being more likely. In yet another embodiment, the opening price may be determined by geographical location or through a statistical analysis of historical prices, competing prices, number of clicks, and the like. This disclosure contemplates any suitable algorithm or combination of algorithms for setting Pso without limitation. The seller may also hide Pso from the public when inviting offers.

In another embodiment, Negotiation platform 200 may match sellers of an item with buyers. A seller may post an item for sale with a listing which may include, but not limited to, title, quantity, photos, offer price, and the like. A buyer may also post an item for request with a listing. The listings may be stored in a database. In one embodiment, the offer prices may be a minimum price for the seller and a maximum price for the buyer, and the negotiating platform may automatically determine an initial offer price for each party which is above the minimum price and/or below the maximum price. The Negotiating platform may match a seller and buyer based on the price and/or description (or part of the description). In one embodiment, the Negotiation platform may extract key words from each listing and search all the listings in the database for matches. In another embodiment, the key words extraction may be done through a third party application or web service.

In one embodiment, matches may have confidence levels to determine whether there is a match or not. Negotiation platform 200 may be able to use the confidence levels to determine whether a listing is a duplicate or spam. Negotiation platform 200 may also scan listings for key words that indicate illegal, unwanted, or offensive activity such as the sale of/request for drugs, prostitution, porn, guns, and the like.

While there are many different ways to conduct matching of buyers and sellers, one method may use bi-directional matching. A description of one embodiment of such a bidirectional matching system will be discussed in more detail below.

At 202, Negotiation platform 200 may receive an offer from a buyer to buy the item for sale at price Pbmax. If Pbmax is greater than or equal to Psmin, Negotiation platform 200 at 203a may average Pbmax with Psmin to determine Paverage. Negotiation platform 200 at 204a may, to prevent either parties from easily reverse engineering Psmin or Pbmax, create Pclose by adding or subtracting a random value to Paverage; thus obscuring Paverage. In one embodiment, the random value used to obscure Paverage may be a random percentage taken from a small percentage range. By way of example, the range may be −2% to 2%. In another embodiment, if the case that Psmin=Pbmax occurs, the random change may be wrapped up in a fee to both parties.

This disclosure contemplates any suitable method of preventing the parties from easily discovering Pbmax or Psmin, which would be readily apparent to one of ordinary skill in the arts. In another embodiment, the step of obscuring Paverage 204a may be skipped and Paverage may be used to close the deal.

If Pbmax is less than Psmin, Negotiation platform 200 enters into a negotiation phase 203b where a negotiation agent is provided for each of the buyer and the seller to help negotiate an agreeable price between the parties. The seller's agent attempts to negotiate with the buyer to increase their Pbmax without knowing Pbmax while the buyer's agent attempts to negotiate with the seller to decrease Psmin without knowing Psmin. This is referred to as blind negotiation. According to one embodiment, negotiation platform 200 may be modified such that a buyer could list a request for an item with an initial offer price and maximum offer price (instead of a minimum).

FIG. 3 illustrates an exemplary interaction between Negotiation Platform 300, Buyer 301, Seller's Agent 302, Buyer's Agent 303, and Seller 304 during a negotiation phase. The negotiation platform, which may consist of one or more computer systems, sets up a Seller's Agent 302 and a Buyer's Agent 303. Seller's Agent 302 and Buyer's Agent 303 may be one or more computer systems with one or more processors executing programming instructions. Seller's Agent 302 may actively negotiate with Buyer 101 through Client 306 to increase buyer's offer price while the Buyer's Agent 303 actively negotiates with the Seller 304 through Client 307 to decrease their sale price. Each agent may update each other whenever a better price is obtained.

FIG. 4 is a flow chart of a negotiation phase 400 process based on a seller's listing according to one embodiment. Negotiation phase 400 begins at 401 with providing an automated negotiation agent for each party, Seller's Agent 430 and Buyer's Agent 431, to facilitate negotiations. Seller's Agent 430 initiates the negotiation by providing Psmin and Pso that the seller previously established and the Buyer's current offer Pbo (which may be set by the buyer or automatically set based on a percentage determined with an algorithm similar to the Pso percentage algorithm discussed above). Buyer's Agent 431 initiates with Pbmax, Pso and Pbo. According to one embodiment, a description and tutorial regarding the negotiation process may be provided to either the buyer or seller. According to another embodiment, assurances may be provided to the seller and buyer that Psmin and Pbmax will stay hidden.

A maximum number of negotiation rounds may be set at 402, which may determine the maximum number of rounds each agent is allowed to perform. According to one embodiment, the maximum number of negotiation rounds may be a random number selected from a predetermined range. For example, the number of rounds may be a random number between 7-10 preset by the negotiation platform. In another embodiment, the number of negotiating rounds may be set by the respective parties. In yet another embodiment, the negotiation rounds may be unlimited. The number of rounds for each agent may be required to be equal, or the number of rounds for each agent may be different. Any suitable method or combination of methods for establishing a number of negotiating rounds for each agent is contemplated in this disclosure.

At 403, Each agent begins negotiating with its opposing party. Seller's Agent 430 may independently negotiate with the buyer to increase Pbmax while Buyer's Agent 431 negotiates a lower Psmin. Pbmax may be unknown to Seller's Agent 430, and Psmin may be unknown to Buyer's Agent 431.

According to one embodiment, at 404a, Seller's Agent 430 may initially set a potential offer to the buyer, Ps, below Pso. Seller's Agent 430 may lower Ps by a fixed percentage. This percentage may be provided by the Seller or set by the agent. In one embodiment, the percentage used to lower the initial offer is variable within a predetermined range. For example, Seller's Agent 430 may lower the potential offer by a randomly selected percentage between 10-20%. In another embodiment, a seller may be able to set a value representing the level of negotiation toughness that the seller wants to project into the negotiation, which affects the percentage used to lower Ps. The higher the level of negotiation toughness, the lower the set percentage or percentage range and/or the increased weight on lower percentages during a random selection process.

Seller's Agent 430, at 405a, determines whether Ps is below Psmin. If Ps is not below Psmin, Seller's Agent 430 continues to 406a, otherwise, Seller's Agent 430 checks to see if Buyer's Agent 431 was able to lower New Pso such that New Pso is not above Ps at 407a. If New Pso is not above Ps, Seller's Agent 430 updates Psmin with New Pso at 409a and continues to 406a. If Pso is above Ps, negotiations end and no deal is achieved.

At 406a, Seller's Agent 430 shows Ps to the Buyer and asks the Buyer to give a new offer (New Pbo) which is above the current Pbo. At 410a, if the buyer does not increase Pbo, no deal is achieved. Otherwise, Seller's Agent 430 continues to 411a where the New Pbo is reported to Buyer's Agent 431. The New Pbo may be used by the Buyer's Agent 431 at 407b where Buyer's Agent 431 compares New Pbo and Pb. At 412a, Seller's Agent 430 determines whether New Pbo is less than Ps. If New Pbo is not less that Ps, the deal is closed with the deal price being the average between New Pbo and Ps. Otherwise, Seller's Agent 430 checks to see if more negotiations rounds are allowed. If more rounds are allowed Ps is reduced by a percentage and steps 405a-413a are repeated. According to one embodiment, the percentage reduction may be by a set percentage, a random variable percentage which may be with a predetermined range and a weight may also be applied. According to another embodiment, a toughness setting may be set by the Seller which influences the percent reduction. In yet another embodiment, Ps may be reduced based on the Buyer's increase from Pbo to New Pbo. For example, a fraction or multiplier (including 1) of the increase may be used for the reduction.

At the same time, as Seller's Agent 430 is negotiating with the buyer, Buyer's Agent 431 is negotiating with the Seller. The Seller Agent's negotiation may or may not be synchronized with the Buyer's Agent's negotiation. At 404b, Buyer's Agent 431 may initially determine Pb which may be the same as Pbo. At 405b, Buyer's Agent 431 may determine whether Pb is greater than Pbmax. If Pb is not greater than Pbmax, Buyer's Agent 431 continues to 406b, otherwise, Buyer's Agent 431 checks to see if the Seller's Agent 430 was able to increase New Pbo at 407b. At 407b, if New Pbo was increased such that it is not below Pb, Buyer's Agent 431 updates Pbmax with New Pbo at 409b and continue to 406b. If New Pbo is below Pb at 407b, negotiations end and no deal is achieved.

At 406b, Buyer's Agent 431 shows Pb to the Seller and asks the Seller to provide a lower sale offer (New Pso) which is below the current Pso. At 410b, Buyer's Agent 431 checks to see if a New Pso is provided. If the seller does not reduce Pso, no deal is achieved. Otherwise, Buyer's Agent 431 continues to 411b where the New Pso is reported to Seller's Agent 430. Seller's Agent 430 may compare New Pso and Ps at 407a.

At 412b, Buyer's Agent 431 determines whether Pb is below New Pso. If Pb is not below New Pso, the deal is closed with the deal price being the average between New Pso and Pbo. Otherwise, Buyer's Agent 431 checks to see if more negotiation rounds are allowed. If more rounds are allowed, Pb is increased again and steps 405b-113b are repeated. Pb may be increased in a similar manner as how the Seller's Agent decreases Ps. For example, a set percentage or a percentage where the buyer may provide a toughness setting which affects how much Pb is increased. In another embodiment a fraction or multiple of the amount New Pso decreased from Pso may be used to increase Pb.

FIG. 2 provides by way of example an illustration of a negotiation phase according to an embodiment where a listing for sale is provided by a seller. This disclosure also contemplates a negotiation phase conducted based on a buyer's request listing instead of a sales listing from a seller. Negotiation Phase 400 would easily be modified by a ordinarily skilled artisan to conduct such a negotiation.

According to one embodiment, the Seller and/or Buyer may use an Autopilot system to negotiate with either the Seller's Agent 430 or Buyer's Agent 431. According to another embodiment of the autopilot system, the seller and/or buyer may provide a stop limit price that the seller and/or buyer is unwilling to cross (represented as Psh for the seller and Pbh for the buyer) and a flexibility number (flex) which affects how quickly an offer changes. The Autopilot system may use the following algorithm when an agent requests a better offer:

For the Seller:

New Pso=Psh+(Pso−Psh)×(1−flex) Equ. 1

or

For the Buyer:

New Pbo=Pbh−(Pbh−Pbo)×(1−flex). Equ. 2

In one embodiment, flex may be set by the negotiation platform rather than the seller and/or buyer. The Autopilot algorithm above is provided only by way of example and many other algorithms may be implemented and contemplated in this disclosure. One of ordinary skill in the art will recognize multiple algorithms suitable for the Autopilot system discussed above. Any suitable algorithm, or combination thereof, may be used with the Autopilot system. Other suitable algorithms may or may not require a Pbh and a flex.

In another embodiment, the negotiations may take place in real time. In yet another embodiment, the deals based on the negotiations based on the various embodiments disclosed above may be closed in real time.

In a further embodiment, a bidirectional matching system may be used. In such a system, a buyer provides a listing of what the buyer desires to buy. When the buyer provides his list, all sellers having goods or services that match the buyer's request are notified of the buyer's request, and simultaneously, the buyer is notified by the system of all of the goods and services from various sellers that meet his request.

The buyer's request is stored in a memory of the system so that even if, at the time the buyer makes the request, there are no matching items or services for sale, the buyer will be immediately notified when a seller offers to sell a matching good or service. In other embodiments, the buyer may remove his request from the system after a period of time, or, in the alternative, place his request on hold, which prevents the matching system from matching the request to goods and services available for sale. Such a hold may be removed by the buyer at the buyer's discretion, which will then make the buyer's request available for matching.

The various embodiments of the invention includes one or more databases in which the various buyer's requests and sellers offers are stored. A typical listing, which, for convenience, will be used hereforeward as pertaining to both a buyer's request and a sellers offer, will include, for example, but not limited to, an identification of good or service requested or sold, a quantity, a brief or detailed description, minimum prices for sold items or services or maximum prices for requested items or services, photos and the like.

In some embodiments, as described above, key words may be extracted from the listing, and may also have a confidence value associated with the key word by the system. When a match is processed, the system searches lists of key words to determine a match. The system also analyzes the confidence value associate with the key words. In one embodiment, the confidence of each key word is the multiplication of the confidence value of the key word associated with a listing and the confidence value of a matched listing's key word.

In various embodiments, a matching record will also be stored in the database. The matching record includes information related to a match, which may also include a confidence value, along with quantity and price information.

The confidence value of a matching can be defined as the ration between the sum of the confidence values of the matching record's key words to the sum of the square of the confidences of the principle listing's keywords. For example, if a buyer is requesting to buy a piano, the key words associated with the “Piano” request may be “Piano” and “Musical Instruments.” In this example, the confidence value for the key word piano is 70% and the confidence value for the key word musical instrument is 30%.

A French horn offered for sale may have key words of French horn, with a confidence value of 50%, musical instrument, 20%, and France, 30%. In this example, the confidence of the principle key word, piano, to the French horn's keywords may be calculated as:

30%×20%=6% Equ. 3

The matching confidence is thus:

$$\frac{6 \%}{( 70 {\%}^{2} + 30 {\%}^{2} )} = 10.3 \% \qquad Equ . 4$$

In one embodiment of a typical matching, the user enters a sell or buy listing, and the system extracts key words and calculates confidences values from the listing information. The system checks for illegal key words, rejects them. The system then queries all listing that include the same key words and creates matching records, and discards record with a confidence value of less than 20%. The system may also check for duplicate listings, such as where the matching confidence value is higher than a predetermined value, which may be, for example but not limited to, 80%, are of the same kind (that is, buy or sell), belongs to the same user of the system, or which the system determines is spam. The system may then discard matching records of listings of the same kind, or records that are not relevant to the matching being carried out. When the system completes the matching process, the system notifies the creator of the principle listing of all matching records.

One problem that may be encountered is the incursion of the system by spam. For example, the inventors have determined that three kinds of spam may be encountered: illegal or non-compliant listings, such as listing that are for goods or services that are either illegal, or which violate the policies of the system, such as listing for buying or selling drugs, pornography, sex services and the like. Such listings, if they evade the spam handling procedure which is discussed below, may also be added to a spam list containing reports of such by users, which list may then be used to reject inappropriate or illegal listings.

The system may also encounter “real” spam which is defined as repeated listing of the same good or services by the same user. This type of spam may be detected by analyzing the listings to detect such duplicate listings, or they may also be reported by users of the system. Another type of spam is offensive listings. Such listing may not be found by the system, but may be reported by users of the system.

When spam is either detected by the system or reported by a user, the listing may be suspended. A report may be sent to site manager, where the various embodiments of the present invention are included in a web site or other e-commerce or brick and mortar commerce facility, or they may be sent to the operators of the system for review.

The site manager may then contact the listing's owner for clarification. Upon clarification, the listing may be either removed, or taken off suspension. In serious or repeat cases, a decision may be made to suspend or terminate the owner of the listing's account.

It will be understood that the various embodiments of the invention are embodied in software programs which include programming instructions which are implemented using a server or client computing device. Such computing devices will have processors which are controlled by the programming instructions of the software, and may also have memory facilities for storing both the programming instructions, and data related to listings, matchings and results.

FIG. 5 illustrates an exemplary computer system 500 which may be used with some embodiments of the present invention. Computer system 500 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. Computer system 500 may be a combination of various types of systems. Computer system 500 may include one or more computer systems 500, be unitary or distributed, span multiple locations, span multiple systems, or reside in a cloud (which may include one or more cloud components in one or more networks).

In one embodiment, computer system 500 may include one or more processors 502, memory 503, storage 504, an input/output (I/O) interface 505, a communication interface 506, and a bus 507. Although this disclosure describes and illustrates a particular computer system having a particular number of particular components in a particular arrangements, this disclosure contemplates other forms of computer systems having any suitable number of components in any suitable arrangement.

In one embodiment, processor 502 includes hardware for executing instructions, such as those making up software. Herein, reference to software may encompass one or more applications, bytecode, one or more computer programs, one or more executables, one or more instructions, logic, machine code, one or more scripts, or source code, and vice versa, where appropriate. As an example and not by way of limitation, to execute instructions, processor 502 may retrieve the instructions from an internal register, an internal cache, memory 503 or storage 504; decode an execute them; and then write one or more results to an internal register, an internal cache, memory 503, or storage 504. In one embodiment, processor 502 may include one or more internal caches for data, instructions, or addresses. Memory 504 may be random access memory (RAM), static RAM, dynamic RAM or any other suitable memory. Storage 506 maybe a hard drive, a floppy disk drive, flash memory, an optical disk, magnetic tape, or any other form of storage device that can store data (including instructions for execution by a processor).

In one embodiment, storage 504 may be mass storage for data or instructions which may include, but not limited to, a HDD, solid state drive, disk drive, flash memory, optical disc (such as a DVD, CD, Blue ray, etc.), magneto optical disc, magnetic tape, or any other hardware device which stores may store computer readable media, data and/or combinations thereof. Storage 504 maybe be internal or external to computer system 500.

In another embodiment, input/output (I/O) interface 505 includes hardware, software, or both for providing one or more interfaces for communication between computer system 500 and one or more I/O devices. Computer system 500 may have one or more of these I/O devices, where appropriate. As an example, but not by way of limitation, an I/O device may include one or more mouses, keyboards, keypads, cameras, microphones, monitors, display, printers, scanners, speakers, cameras, touch screens, trackball, and the like.

In still another embodiment, a communication interface 506 includes hardware, software, or both providing one or more interfaces for communication between one or more computer systems or one or more networks. Communication interface 506 may include a network interface controller (NIC) or a network adapter for communicating with an Ethernet or other wired-based network or a wireless NIC or wireless adapter for communications with a wireless network, such as a WI-FI network. In one embodiment, bus 507 includes any hardware, software, or both coupling components of a computer system 500 to each other.

While particular embodiments of the present invention have been described, it is understood that various different modifications within the scope and spirit of the invention are possible. The invention is limited only by the scope of the appended claims.

We claim:

1. A computer implemented method for negotiating a price comprising:
receiving a maximum price and minimum price;
assigning a first computerized negotiating agent to a first user;
assigning a second computerized negotiating agent to a second user;
determining a first offer and a second offer;
the first agent increasing the first offer price and displaying it to the second user and requesting a first new price from the second user; and
the second agent decreasing the second user's offer price and displaying it to the first user and requesting a second new price from the first user.

2. The method of claim 1 further comprising:
receiving a first listing from the first user;
receiving a second listing from the second user; and
determining whether the first listing matches the second listing.

3. A system comprising:
one or more processors;
one or more displays; and
logic encoded in one or more non-transitory computer-readable media that, when executed by the one or more processors, is operable to:
receive a maximum price and a minimum price from one or more users;
determine a first user's offer and a second user's offer;
increase the first user's offer price and request a first new price from the second user; and
decrease the second user's offer and request a second new price from the first user.

4. The system of claim 3 further comprising:
logic encoded in one or more non-transitory computer-readable media that, when executed by the one or more processors, is operable to:
receive a first listing from the first user;
receive a second listing from the second user; and
determine whether the first listing matches the second listing.

5. A non-transitory computer-readable medium storing instructions that, when executed by a processor, perform a method comprising:
receiving a maximum price and minimum price;
assigning a first computerized negotiating agent to a first user;
assigning a second computerized negotiating agent to a second user;
determining a first user's offer and a second user's offer;
the first agent increasing the first's offer price and displaying it to the second user and requesting a first new price from the second user; and
the second agent decreasing the second user's offer price and displaying it to the first user and requesting a second new price from the first user.

6. The non-transitory computer-readable medium of claim 5 further comprising instructions that, when executed by a processor, perform a method comprising:
receiving a first listing from the first user;
receiving a second listing from the second user; and
determining whether the first listing matches the second listing.
